(19) United States
(12) Patent Application Publication
(10) Pub. No.: US 2025/0211384 A1
(43) Pub. Date: Jun. 26, 2025

(54) OPERATING A UNIVERSAL DATA TRANSPORT SYSTEM

(71) Applicant: INOVA SEMICONDUCTORS GMBH, Munich (DE)

(72) Inventors: Roland NEUMANN, Bad Toelz (DE); Fabian KLUGE, Perasdorf (DE)

(21) Appl. No.: 19/077,755

(22) Filed: Mar. 12, 2025

Related U.S. Application Data
(63) Continuation of application No. PCT/EP2023/076115, filed on Sep. 21, 2023.

(30) Foreign Application Priority Data
Sep. 27, 2022 (EP) 22198220.0

(51) Int. Cl. H04L 5/00; H04L 5/14; H04L 47/24

(52) U.S. Cl. CPC H04L 5/0044; H04L 5/14; H04L 47/24

(57) ABSTRACT

A method is provided for operating a universal data transport system designed for vehicle architectures in view of special limitations. The method can transport particularly hardware-efficient data. The hardware efficiency may reflect that only one physical data channel is necessary and the corresponding components can be provided with little complexity. Also provided is a data transport system which carries out the proposed method or a computer program with control commands, with the computer program carrying out the method or operating the data transport system. Also provided is a computer-readable storage medium.

### CROSS REFERENCE TO RELATED APPLICATIONS

This application is a continuation of International Application No. PCT/EP2023/076115, filed on Sep. 21, 2023, which takes priority from European Application No. 22198220.0, filed on Sep. 27, 2022 the entire contents of each of which are incorporated by reference herein.

### TECHNICAL FIELD

The present invention is directed to a method for operating a universal data transport system that has been specially designed for vehicle architectures, as particular restrictions prevail here. The proposed method or data transport system is designed to transport data in a particularly hardware-efficient manner. This hardware efficiency is reflected in the fact that, for example, only one physical data channel is required and the corresponding components can be provided with low complexity. The present invention is further directed to a data transport system which executes the proposed method or to a computer program product with control instructions which execute the method or operate the data transport system. In addition, a computer-readable storage medium is proposed.

### BACKGROUND

US 2017/0019479 A1 shows a communication in communication networks, in particular for a flexible deterministic communication network and a method for use in a vehicle, e.g. an aircraft, a spacecraft or a ship or other vehicle.

U.S. Pat. No. 10,362,117 B1 shows network interface devices comprising a configuration engine, a mode change engine and a switch.

Various video interfaces are known from the state of the art, which are typically optimized to transmit data via a computer network and then output to a conventional end device. The state of the art typically assumes that high-performance computer systems are available and that sufficient bandwidth is always available. Furthermore, such technologies do not focus on energy efficiency. Energy efficiency typically plays a subordinate role in computer systems, with only temperature development and heat dissipation to be considered. In cars, however, energy consumption directly reduces the range of an electrically powered vehicle.

Well-known interfaces such as Displayport or HDMI typically assume a high bandwidth for the underlying data channel and are not optimized for latency times.

Other state-of-the-art transmission systems also assume a high-bandwidth data connection and transmit data packets over long distances. Technologies used in today's Internet typically work on a packet basis and cover large geographical distances by means of dynamic routing. This implies high-performance network nodes that find an optimal data path through a wide-area computer network at runtime. In automobiles, however, completely different requirements arise, as the spatial extent is smaller and data is often security-relevant. In this respect, state-of-the-art technologies are often not applicable as there are increased security requirements and real-time requirements.

The interfaces listed as examples are each optimized for specific use cases (data types). Depending on the type of interface, they offer either or (but not simultaneously):
Low latency with unidirectional point-to-point or multipoint connection of a specific application less than or equal to 16 nodes (Consumer Video Interfaces: DP/HDMI/DSI/CSI/LVDS)
Low latency for bidirectional point-to-point or multipoint connection with a fixed frame format (and thus fixed allocated bandwidth) to meet latency requirements (APIX2/APIX3)
High latency for point-to-point and multipoint connections with high flexibility (Ethernet, TDM)

The following requirements cannot be fulfilled simultaneously for the interfaces mentioned as examples:
Lowest latency (due to possible prioritisation)
Dynamically allocated bandwidth (no fixed frame format)
Bidirectional data streams
(Multi-Master-)Multipoint data streams>16 nodes
Bundling of all conceivable data types
Gateway function is available everywhere in the network
Minimal protocol overhead

The simultaneous combination of all the above-mentioned properties is desirable as a universal data transport system for new vehicle architectures, as this meets both the increasing complexity and the growing bandwidth requirements. This is currently not possible.

There is a need to propose a method that enables data to be transferred efficiently in vehicle architectures in particular, regardless of the data type. The proposed method is intended to ensure that only a low technical effort is possible or that data can be transported via several network nodes independently of the data formats provided, whereby the network nodes have a low complexity and the structural features have a low weight. It is also a task of the present invention to provide a correspondingly equipped data transport system, as well as a computer program product and a computer-readable storage medium.

### SUMMARY

Accordingly, a method for operating a universal data transport system for vehicle architectures is proposed, comprising dividing at least one physical data channel into a plurality of virtual data channels; reading out user data in a transmitter of the data transport system; adding description data describing the user data to the user data according to a target data format for creating at least one data set; transmitting the at least one data set by means of the virtual data channels from the transmitter to a receiver by means of static addressing, wherein several data streams are bundled and transmitted serially in a transport frame; and receiving the at least one data set by means of the virtual data channels from the transmitter to a receiver by means of static addressing, wherein several data streams are bundled and transmitted serially in a transport frame; transmitting the at least one data set by means of the virtual data channels from the transmitter to a receiver by means of static addressing, wherein several data streams are bundled in a transport frame and transmitted serially; and receiving the at least one data set in the receiver and reading out the user data for its utilization.

In accordance with one aspect of the present invention, the data transport system set out below can combine all of the above requirements simultaneously.

According to one aspect of the present invention, the desired properties are achieved by:
128 virtual data paths to which bandwidth is dynamically allocated (based on prioritization) and which only require bandwidth when data is transferred.
Two generic application adaptation units for burst and stream data, which make it possible to integrate all conceivable interfaces
A segmentation or reassembly unit for each send and receive path that enables the transition of application data to the standardized cell format
A service-independent peer-to-peer interface on the cell layer that enables low-latency repeater/routing functionality in all directions. This is necessary for the arbitrary forwarding (routing) of individual virtual data paths
A crossbar unit for cell merge (TX path) or cell separation (RX path)
Full-duplex design of each serial interface: All virtual 128 channels can be operated in full-duplex mode if required
The option of creating multiple serial interfaces for more bandwidth (x2 x3 x4 . . . ). It is also possible to use an asymmetrical structure, e.g. two TX-PHYs and only one RX-PHY (double bandwidth in the downstream, upstream remains unaffected).

This makes it possible to bundle burst and stream data with the lowest possible latency. This in turn, thanks to the bidirectional structure, enables simultaneous bundling of a large number of interfaces via several functional units in any direction with any input and output points.

The proposed method for operating the data transport system is based on the fact that the data transport system is universal with regard to the user data to be transmitted. Thus, according to embodiments of the invention, it is possible for the user data to be extracted during a data transmission of any data format and then, if necessary, to be repackaged and retransmitted. Typically, data transmitted in a computer network contains surplus data, so-called overhead. This data can be frame data, header data or footer data, for example. These are format-specific, while the user data contains the actual information. In accordance with embodiments of the invention, a method is therefore proposed which separates the overhead data from the user data and is therefore suitable for universal data formats. This means that potentially any data format can be converted into another data format.

The proposed data transport system has several network nodes, which are connected by means of serial data channels, for example a cable. The topology is static, i.e. there is no dynamic routing or addressing, as the network topology is known in advance and this can be dispensed with for reasons of efficiency.

According to the proposed method, a physical data channel is operated, which is subdivided into a plurality of virtual data channels. Preferably, one physical data channel is subdivided into 128 virtual channels. In general, it is also possible to provide several physical data channels, which are then in turn divided into virtual data channels. In general, it is also possible to provide a first number of physical data channels for a first communication direction and a second number of physical data channels for a second communication direction. How physical data channels are subdivided into virtual data channels is sufficiently well known, although it is proposed according to embodiments of the invention that the virtual data channels can be addressed independently of one another.

In accordance with embodiments of the invention, it is thus possible to operate the virtual data channels in such a way that they have different bandwidths and implicitly different latency times. Furthermore, individual data channels can be prioritized.

In addition, user data is read out in a transmitter of the data transport system, which can take place in such a way that the user data is read out from a data source or the transmitter previously acted as a receiver and the user data was transmitted. Reading out user data can also involve reading out the user data from a data stream, whereby excess data, for example frame data, is also transmitted. Reading out the user data then corresponds to extracting the user data from a larger data set that has been transmitted. How the user data is extracted from the data stream or data packets can be determined according to the overhang data. For example, the user data is transmitted in a certain data format, whereby the data format itself provides information about where the user data is to be extracted from within the overall data transmitted. In addition, the readout of user data can imply further components, such as the readout of a measurement sensor or the readout of a data memory, for example a volatile data memory.

In a subsequent process step, description data is added to the user data in accordance with a target data format to create at least one data set. The description data provides information about the content of the user data or describes the user data. While the user data describes the generic raw data, the description data is used to provide metadata that relates in some way to the user data. In the present case, it is not necessary for addressing data to be available, as static addressing takes place in accordance with embodiments of the invention. The target data format can be specified by a network node of the data transport system and determines which data format a recipient of the description data and the user data can read. It is also clear from the target data format which descriptive data is to be added to the user data. The resulting data set then corresponds to the target data format and optionally contains descriptive data as well as the user data.

The at least one data set is then transmitted using the virtual data channels or at least one data channel. No addressing information or dynamic routing is used when transmitting the at least one data set from the sender to the receiver; instead, static routing or static addressing is used in accordance with embodiments of the invention. This is particularly advantageous for a system architecture in an automobile, as all network nodes are known in advance or can be determined in an initialization step. The network nodes are hard-wired and therefore static addressing can also be specified. This has the advantage that the complexity of the individual network nodes can be minimized, resulting in error robustness and a lighter weight.

Static addressing can be carried out for each physical data channel or for each virtual data channel. In this way, addressing information can be specified that indicates the target network node. In general, it is possible for each network node to decide to which subsequent node the data set is to be transmitted, but this is always specified statically. There is no provision for alternating the data paths in the network nodes. Addressing or routing therefore takes place, but this is static and does not vary over the runtime.

After the transmission of the at least one data set, the at least one data set is received by the recipient, which is also a network node of the data transport system. The user data is then read out for utilization, which can mean that the user data is output by means of an output unit or that it is further processed. Further processing can consist of the read-out user data being enriched with description data and the receiver assuming the role of the sender and transmitting the enriched user data to another receiver.

According to one aspect of the present invention, the number of virtual data channels per physical data channel is a maximum of 128. This has the advantage that the proposed method can be implemented in a particularly advantageous manner, since 128 virtual data channels ensure that sufficient bandwidth is available for each data channel and also that a suitable bit length is available, which can be utilized in a particularly advantageous manner with regard to disparity. For example, it was found that 112 bits can be coded particularly advantageously with respect to a bit length of 128, which corresponds to a minimum overhead. This is taken up by embodiments of the present invention and creates data channels of up to 128 bits per physical data channel.

According to a further aspect of the present invention, a bandwidth is allocated separately for each virtual data channel. This has the advantage that the data channels can be set differently depending on the application scenario and thus individual data channels can also be prioritized by allocating them a higher bandwidth. The bandwidth can also be allocated dynamically at runtime.

According to a further aspect of the present invention, all virtual data channels are operated at least temporarily in a duplex mode. This has the advantage that both a simplex mode is possible, although it is possible to switch to a full duplex mode at any time or at least temporarily. This means that the data channels, whether physical data channels or virtual data channels, are operated in a bidirectional mode so that data can be sent in both directions simultaneously.

According to a further aspect of the present invention, there are different numbers of physical virtual data channels per communication direction. This has the advantage that, in the case of directional data communication, there may be directional physical virtual data channels which may not be identical. This means that more data can be sent upstream or downstream, and the corresponding communication direction can be amplified accordingly. The transmission capacity that is required in the application scenario at hand is therefore created in each case.

According to a further aspect of the present invention, virtual data channels are set up exclusively for continuous or discontinuous data sets. This has the advantage that individual interfaces or data channels are provided either for streaming data or for burst data. In this way, particularly efficient structural features can be created or the method can utilize these structural features. For example, the buffer memory can be designed to be larger for continuous data than for discontinuous data. The bandwidths for continuous data on the data channel can also be selected to be correspondingly larger.

According to a further aspect of the present invention, virtual data channels are prioritized independently of each other. This has the advantage that the bandwidth can also be set dynamically at runtime or data channels can also be bundled. In addition, latency times can be specified which must be adhered to and the data channels are prioritized or set up accordingly.

According to a further aspect of the present invention, network nodes of the data transport system act alternately as transmitters or receivers. This has the advantage that the role of sender or receiver can be assumed alternately by network nodes, so that different network topologies can be created. It is therefore possible to have network nodes that only represent data sources, i.e. transmitters, and network nodes that only represent data sinks, i.e. data receivers. In addition, there can also be addressing network nodes that act as both senders and receivers.

According to a further aspect of the present invention, the user data is output in the receiver by means of an output unit and/or the receiver represents a data sink. This has the advantage that individual network nodes can only receive data and these output the data, for example by means of a screen and/or a loudspeaker, and do not generate any data of their own. Such network nodes can then be referred to as data sinks.

According to a further aspect of the present invention, the method uses only volatile memory. This has the advantage that no data is stored persistently and, in this respect, the network components or the network nodes do not have to be designed in a complex manner. Volatile memories are typically faster and more efficient than persistent memories. This is based on the application scenario in cars, which requires particularly simple components.

According to a further aspect of the present invention, bidirectional routing is carried out within the transmitters. This has the advantage that there are individual network nodes which serve as routers or addressing units or also as so-called gateway routers.

According to a further aspect of the present invention, the user data is available as video data audio data. This has the advantage that a method is created which specifically addresses the requirements in automobiles and also allows large amounts of data to be transmitted efficiently. The invention may be implemented with these data in a particularly advantageous way, as the static addressing means that even large amounts of data can be transmitted efficiently and there are no high latency times. In this way, these real-time applications can be transmitted particularly favorably in the present method, since video data and audio data must always be transmitted continuously.

One aspect of the present invention is to bundle several data streams (video, audio and data) in one transport frame and transmit them serially. The different data formats not only have different bandwidth requirements, but also different latency, reassembly sublayer and bit error rate requirements. In particular, the transmission of today's video data formats requires not only the transmission of pure video data and its frame information, but also the support of encryption methods such as HDCP. All of this requires many different data channels with a wide range of requirements in terms of bandwidth, latency, reassembly sublayer, etc. Added to this is the desire for far more complex network architectures than a simple transmitter/receiver architecture offers. Architectures with several repeaters, where data paths can begin and end, branches (Y) and the possibility of reintegrating data paths into a link are advantageous.

According to one aspect of the present invention, the technology follows the basic idea of consistently bundling several services, but offers completely new possibilities with regard to network architectures and allows new approaches in the implementation of today's video interfaces. In addition, it can be used as a universal data transport layer, for example also for transmitting Ethernet or camera data or any type of sensor data.

With a virtual path, all packets/cells take the same path, in contrast to IP, where a packet could reach its destination via a different route than previous and subsequent packets. Latency and reassembly sublayers over a virtual path are therefore constant.

Virtual paths also have the advantage that they can be used as a multiplexing layer for different services (video, audio, Ethernet), as the properties of the virtual paths can be configured differently without the different virtual paths interfering with each other.

Virtual paths only consume bandwidth when data is actually being transferred.

The concept of virtual paths also makes it possible to realize complex and far-reaching diagnostic and network configuration functions at runtime with separate (virtual) data channels.

According to one aspect of the present invention, a virtual path layer is implemented between the physical layer (serializer and framer) and the various application data interfaces.

According to one aspect of the present invention, this is used to multiplex the various data paths and support more complex architectures with repeaters and branches. This is mainly done in the cell layer.

According to an aspect of the present invention, a further part of the Virtual Path layer is an application adaptation layer which performs the conversion of video (stream) or e.g. Ethernet (packet) data into the cells. This application adaptation layer also comprises the OAM functions for network diagnostics and management.

According to one aspect of the present invention, the technology can be the basis for transmitting a variety of data formats via a serial connection in the car (and elsewhere). It thus forms the basis for a new generation of devices.

The high serial bandwidths make it necessary to define architectures, cell formats and interfaces that enable flexible internal data bus widths in order to adapt the speed of the internal clock system to the possibilities of the chip technology.

According to one aspect of the present invention, the virtual path layer includes the physical layer comprising the transmission sublayer and the physical medium sublayer, the cell layer and the application adaptation layer comprising the segmentation and reassembly sublayers and the functions for adapting the data formats to the corresponding application.

The main task of the physical layer is to establish the physical connection to other physical layers. This connection is basically bidirectional. Theoretically, this connection can be realized via a wide variety of media. In practice, two serial differential GBps connections are used. In this layer, the line coding, the insertion of empty cells to decouple the cell rate from the connection rate and the integration of the cell stream into the serial frame take place.

In the cell layer, the segmented data (cell payload data) of the segmentation & reassembly sub-layer above is assembled into complete cells with header, VP identifier and CRC or cells are CRC-checked and the payload is passed on to the segmentation and reassembly sub-layer. This is also where the multiplexing of the different cell streams of the application customization functions or the distribution of the cell payloads to the application customization functions according to the VP identifier takes place. (Feed-in/Feed-out)

According to one aspect of the present invention, multiplexing and demultiplexing of cell streams in repeaters and splitters (forwarding) also takes place in the cell layer.

According to one aspect of the present invention, the task of the application adaptation functions is to adapt the data of the application interfaces to the format of the user data field of the cell and to transmit control information to the opposite side or to transmit control information of the opposite side for the adaptation to be used (time generation, frame formation).

According to one aspect of the present invention, all virtual data paths are unidirectional, i.e. they start at an initiator and end at one or more targets. If virtual data paths logically belong together, e.g. HDCP for a video channel, and thus form a bidirectional data path, these paths should have the same VP identifiers.

The virtual data path begins with an initiator and ends with one or more targets. It is realized by the cell sublayer and executes the following functions on the virtual path:
Add/delete multiplexing
VP translation

The problem is also solved by a data transport system for vehicle architectures comprising a subdivision unit arranged to subdivide at least one physical data channel into a plurality of virtual data channels; an interface unit arranged to read out user data in a transmitter of the data transport system; a packaging unit arranged to add description data describing the user data to the user data in accordance with a target data format to create at least one data set; a transmitting interface unit set up for transmitting the at least one data set by means of the virtual data channels from the transmitter to a receiver by means of static addressing, wherein several data streams are bundled in a transport frame and transmitted serially; and a receiving interface unit set up for receiving the at least one data set in the receiver and reading out the user data for their use.

The task is also solved by a computer program product with control commands that implement the proposed method or operate the proposed device.

According to embodiments of the invention, it is particularly advantageous that the method can be used to operate the proposed devices and units. Furthermore, the proposed devices and units are suitable for carrying out the method according to the invention. Thus, in each case the device implements structural features which are suitable for carrying out the corresponding method. However, the structural features can also be designed as method steps. The proposed method also provides steps for implementing the function of the structural features. In addition, physical components can also be provided virtually or virtualized.

### BRIEF DESCRIPTION OF THE DRAWINGS

Further advantages, features and details of the invention are apparent from the following description, in which aspects of the invention are described in detail with reference to the drawings. The features mentioned in the claims and in the description may each be essential to the invention individually or in any combination. Likewise, the above-mentioned features and the features further described herein may be used individually or in any combination. Functionally similar or identical parts or components are sometimes provided with the same reference signs. The terms “left”, “right”, “top” and “bottom” used in the description of the embodiments refer to the drawings in an orientation with a normally legible figure designation or normally legible reference signs. The embodiments shown and described are not to be understood as conclusive, but are of an exemplary nature to explain the invention. The detailed description is for the information of the skilled person, therefore known circuits, structures and methods are not shown or explained in detail in the description so as not to impede the understanding of the present description.

FIG. 1 shows a schematic flowchart of a method of operating a universal data transport system according to one aspect of the present invention;

FIG. 2 shows an exemplary network based on defined functional units of the proposed system arrangement according to a further aspect of the present invention; and

FIG. 3 shows the proposed data transport system according to a further aspect of the present invention.

### DETAILED DESCRIPTION

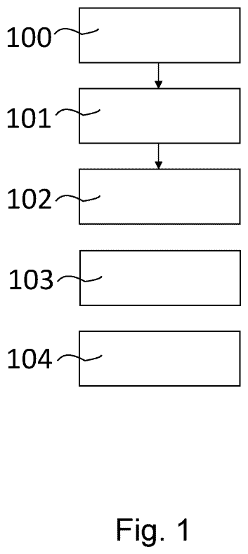

FIG. 1 shows in a schematic flow chart a method for operating a universal data transport system for vehicle architectures, comprising dividing 100 at least one physical data channel into a plurality of virtual data channels; reading out 101 user data in a transmitter of the data transport system; adding 102 description data, which describe the user data, to the user data in accordance with a target data format for creating at least one data set; and transmitting 103 the at least one data set by means of the virtual data channels from the transmitter to a receiver by means of a static addressing, whereby several data streams are bundled and transmitted serially in a transport frame; transmitting 103 the at least one data set by means of the virtual data channels from the transmitter to a receiver by means of static addressing, wherein several data streams are bundled in a transport frame and transmitted serially; and receiving 104 the at least one data set in the receiver and reading out the user data for its utilization.

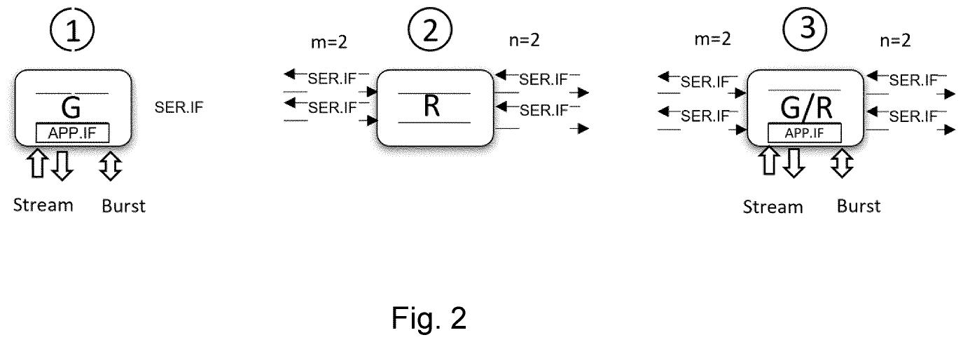

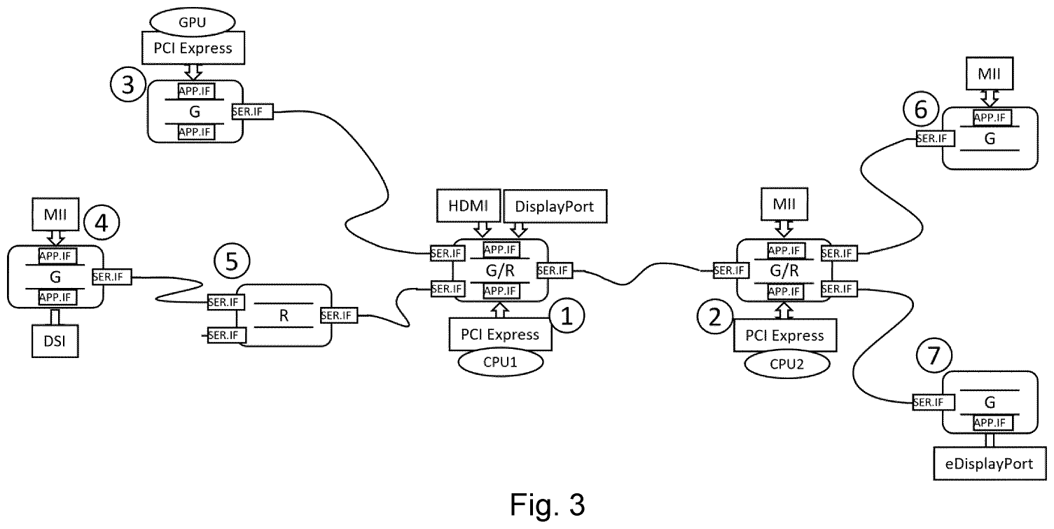

FIG. 2 shows different network nodes of the proposed data transport arrangement or data transport system. The network nodes can act as transmitters receivers and can also act as data sources or data sinks. In addition, inputs and an output are shown in the left-hand component for streaming data, i.e. continuous data, and breast data, i.e. discontinuous data. A communication direction is also shown, which can be dual simplex or bidirectional. The network nodes shown can be combined, as shown as an example in FIG. 3, but can also be used in a different arrangement or topology to create the proposed data transport system.

A function family can thus be defined which, in simplified terms, consists of three function units. These functional units can be described as follows:
1. A pure gateway (G) (also known as a transceiver) that can pack/unpack stream and/or burst data
2. A pure router (R) or m×n crossbar (m,n∈N) that can route data in any direction.
3. An m×n gateway router (G/R) (m,n∈N) that can route data in any direction as well as pack/unpack stream and/or burst data.

Any other combination is possible based on the concept described above. The functional units shown are intended to provide an insight into the flexibility of the architecture.

FIG. 3 shows the proposed data transport arrangement or the data transport system, which is operated in accordance with the proposed method. The components from FIG. 2 are used here in a particularly advantageous way. The data transport system is used in automobiles.

CPU1 and CPU2 can communicate bidirectionally via the respective 1×2 gateway router (1) and (2) via PCI Express and also address gateway (3) via PCI Express, also bidirectionally. At the same time, CPU1 can feed video data into the 1×2 gateway router (1) via HDMI and DisplayPort, which can then be output again as DSI to gateway (4) and eDisplayPort to gateway (7). In addition, CPU2 can use the bidirectional MII interface on the 1×2 gateway router (2) to operate the gateways (4) and (6) as well as the router (5). Router (5) shows an unused serial interface which can be used for later network expansions, for example.

The network shown is to be understood as an exemplary structure. Networks of any complexity with all conceivable application interfaces in all directions are conceivable.

The gateways, routers and gateway routers presented here enable completely new network and data architectures in the vehicle, as there is a uniform transport layer that can route and bundle all existing interfaces in every direction to every gateway/router/gateway router, even with the lowest latency requirements and also optimum utilization of the bandwidth, and can also perform “interface bridging” if required (assuming the same data type, e.g. for the video data type, a DisplayPort input at a gateway to DSI output at another gateway).

In addition, plug connections, cables, weight, electrical energy and ultimately costs can be saved in the vehicle through bundling.

The susceptibility to errors of such a bundled network is conceivably lower compared to many individual point-to-point connections. In addition, error diagnosis in a network such as the one presented can also be greatly simplified by bundling.

The network shown in this setup can be easily expanded by using a router/gateway router, opening up new possibilities for model maintenance and equipment options, for example.

### Sublayer of the Physical Medium

### Purpose and Function

The bottom layer of the physical medium is electrically connected to the physical transmission medium. The primary transmission medium is a differential 100 ohm line. However, optical transmission media can also be considered as an option.

The physical transmission format depends on the data rate and is either NRZ for low data rates or PAM4 for high data rates.

This layer implements the serialisation of the M-bit-parallel line-coded data (M=raw serializer bit width) on the transmitting side and the recovery of the serial clock and the bit-serial data as well as the deserialisation to M-bit-parallel line-coded words on the receiving side. Serial data transmission is based on the concept of the “embedded clock”, i.e. no time is transmitted, only serial data, which enables time recovery due to the line coding.

The core clock frequency is mainly determined by the “raw bit width” M of the SERDES. At 30 GBps and a raw bit width of M=128, for example, this results in a core clock frequency of 234.375 MHz.

### Interface to the Physical Medium

In the direction of the transmission medium, the sublayer of the physical medium according to one aspect of the present invention implements two unidirectional, differential, bit-serial 100 ohm interfaces. A transmit interface and a receive interface. The physical medium comprises a differential forward line and a differential return line throughout. This arrangement also enables the optional operation of optical media without major adaptation circuits.

For the physical medium, the focus is on twisted pair cables, as the insertion loss of coaxial cables at higher frequencies is equal to the insertion loss of twisted pair cables. If the 6 dB attenuation of single-ended transmission compared to differential transmission is taken into account, there is absolutely no advantage left for coaxial cables.

The maximum cable length depends on the data rate (and the cable diameter).

According to one aspect of the present invention, a bit time system for serializing the data is generated in the transmission direction using a PLL. The data/symbols are transmitted with this bit time. This bit time forms the basis for the synchronous Tx clock system. The Tx data path is orientated in the opposite direction to this time system. (synchronous target)

In the receive direction, the time used to serialize the data is recovered from the received serial data stream using a CDR. This time forms the basis for the synchronous Rx clock system. The Rx data path is directed in the same direction as this time system (synchronous source).

A said that the core clock frequency is mainly determined by the “raw bit width” M of the SERDES. For example, 30 GBps and a raw bit width of M=128 results in a core clock frequency of 234.375 MHz. As SERDES technologies can vary, M will also vary. Consequently, the cell format and the cell data interfaces between the different layers must support flexible raw SERDES bit widths, or the cell format must be decoupled from the cell line data width.

### Transmission Sublayer

### Purpose and Function

According to one aspect of the present invention, the transmission sublayer generates the M-bit wide symbols of the line code for the SERDES raw interface from the N-bit wide transmission frames (see: 7. Transmission frames and cell format) in the transmit direction and generates the N-bit wide transmission frames again from the M-bit symbols of the SERDES raw interface in the receive direction.

The main function of the transmission sublayer is to assemble the transmission frames from the cells in the transmitting direction and, conversely, in the receiving direction, to break down the transmission frames into cells.

In order to adapt the data rate of the cell stream to the data rate of the serial transmission, this layer can insert empty cells in the transmission direction (from the application interface to the serializer) in accordance with one aspect of the present invention. The availability of cells depends on the total bandwidth requirements of all application interfaces. Thus, according to an aspect of the present invention, the cells do not form a continuous flow of cells, as the cells are processed (collected, assembled and merged) with core clock that exceeds the maximum bandwidth of the SERDES.

In the receive direction (from the deserializer to the application interfaces), the empty cells are discarded here. Cells are extracted from the serial frame. As the cell data rate is lower than the bandwidth in relation to the core time as in the send direction, these cells are forwarded with a data validity signal.

This layer handles the flow of cells. In addition to the generation of cell headers and CRCs or the extraction with CRC check of the data from the cells, a so-called add-drop multiplexer function is implemented here.

This means that in the sending direction, the cells are collected by the various service functions, provided with a VP identifier, cell header and footer are generated and collected by the peer-to-peer interface and then multiplexed into a common cell stream (add function).

In the receive direction, according to one aspect of the present invention, the cell stream is distributed from the input device in the receive direction to the various service functions and the peer-to-peer interface according to the VP identifier. The data for the service functions is unpacked and CRC-checked (drop function). All cells whose VP identifier does not belong to a service function are forwarded to the peer-to-peer interface (forward function).

### Application Adaptation Layer(s) AAL

The application customization sub-layer is the “top” layer in the three-layer model. This is where the virtual data paths based on cells are converted back into physical data paths. These are connected to the various application interfaces via generic service interfaces for stream or burst data.

The rules for splitting and reassembling packets and streams into cells are called application customization sub-layers.

The two most important are Stream Data for video and audio data, for example, and Burst Data for almost all types of packets. Which AAL is used in each case is not coded in the cell. Instead, it is configured between two endpoints or agreed based on a virtual connection.

### Segmentation & Re-Assembly Sublayer (With AAL Function)

### Purpose and Function

In the transmission direction, the segmentation layer together with the application-specific AAL function according to one aspect of the present invention implements the starting point for the cell-based virtual data paths.

In the receive direction, the reassembly layer together with the application-specific AAL function implements the end point for the cell-based virtual data paths.

The main task of the Segmentation & Re-Assembly sub-layer (together with the application-specific AAL function) is to enable the format conversion (bit-wide) of streamed or burst data with an arbitrary bit width into the N-bit wide cell line data format.

The interfaces between the stream data or burst data functions to the segmentation & reassembly sublayer have the bit width of the cell rows (N). The stream data or burst data AAL functions combine the clock domain crossing and the bit-wide conversion of the data from the application interface to the N bits of the cell rows. The cell line payload is already formatted so that the cell footer and header fit into the first and last cell line.

The Segmentation & Re-Assembly sub-layer basically controls the data flow through the AAL functions. It evaluates the availability of application data and (possibly) the acceptance of cell data (counter-pressure to be defined).

According to one aspect of the present invention, the cells offer the possibility of transmitting payload information data in addition to payload data. (See 7.1 Cell format). The payload information data is used, for example, to generate frame signals for video or audio in the case of stream data and to generate packets, transactions or bursts in the case of burst data.

### Binding of Frame Signals to Stream Data With the Payload Information

The basic idea of connecting frame signals to the data stream is to define a significant anchor point (or several anchor points) in the frame timing and to transmit this (or these) using the payload info bits in such a way that clear synchronization of the data stream and frame signals is possible. Ideally, this is done by placing a fixed point of the data stream at a fixed point in the marked data cell. To restore the frame timing, a free-running timing generator is used, which can generate the entire timing independently. The timing is now adapted to the data stream by analysing the payload info bits and adapting the timing to the defined position in the data cell.

### Stream Data (Continuous Data Stream)

The stream data interface combines the transition from the application clock domain to the cell clock domain and the conversion of the bit width of data from the application interface to the N bits of the cell rows. The cell row payload is already preformatted so that the cell footer and header fit into the first and last cell row.

Streaming data is (normally) source-synchronized. The clock domain crossing of the data path from the application clock domain to the cell clock domain is performed here.

A data buffer is provided in the sending direction, into which the source-synchronized data is written with the application clock. The input device in the sending direction retrieves the data from this buffer as required in order to perform the data format conversion into the N-bit wide rows of cells. Frame signals (e.g.: Hsync, Vsync, DE) are encoded in payload info bits so that the frame signals can be reconstructed on the receiver side.

In the receive direction, the cell data is written to a data buffer by the output device in the receive direction. The frame signals are reconstructed based on the payload info bits. The application clock on the transmit side is regenerated, for example, using buffer fill level and clock synthesis.

If data encryption is required (HDCP), the cell data is encrypted or decrypted in this function.

Due to the different types of stream data, such as: Audio, video with and without encryption, there may be different implementations of this basic function (e.g.: VStream In/Out; AStream In/Out; Enc VStream In/Out).

### Burst Data (Discontinuous Data Stream)

The burst data interface combines the overflow from the application clock domain to the cell clock domain and the conversion of the bit width of burst data from the application interface to the N bits of the cell rows. The cell row payload is already preformatted so that the cell footer and header fit into the first and last cell row.

Burst data is (normally) synchronized to an external clock and has different identification signals for direction and data type (address/data/ByteEnable).

This data is normally accompanied by control lines in order to realize a specific protocol.

A data buffer is provided in the sending direction, into which the burst data is written with the interface clock. The input device in the sending direction retrieves the data from this buffer as required in order to perform the data format conversion into the N-bit wide row cells.

In the receive direction, the cell data from the output device is written to a data buffer in the receive direction. The interface control signals are reconstructed based on the payload info bits.

The payload info bits are used to generate the control signals of the application-specific interfaces or to synchronize the protocol state machines in the application-specific interfaces.

Due to the different interfaces that provide burst-like data (SPI, I2C, MII), there may be different implementations of this basic function (e.g.: SPIBurst, I2CBurst, MIIBurst).

Accordingly, there will also be (slightly) different stream in/out interfaces, but their structure should be the same.

### Cell Format/Frame Format

According to one aspect of the present invention, the cell comprises a header with a fixed bit length, a payload area with 4 selectable bit lengths and a footer, again with a fixed bit length.

The cell structure is a sequence of bits as follows:
A 7-bit virtual path identifier (VP) that represents a unique address of the virtual path.
A 3-bit sequence number (SN) that numbers the cells consecutively in their order.
A 2-bit wide cell type (CT) identifier that specifies the length of the user data.
A 3-bit wide payload information (PI) that contains additional information about the payload. This can also be used to synchronize payload data and frame data or control data.
A 10-bit wide CRC polynomial (HCRC) for error protection of the header information. The polynomial has a Hamming distance of 5 up to a bit sequence of 21 bits (P=0x2B9).
The payload (PL) range has a length of: 187, 411, 635 or 859 bits, depending on the CT value. The shortest payload is selected so that it is still larger than the largest supported (video) streaming bus width. (Should simplify the mapping of streaming data to the cell payload).
Finally, a 12-bit wide CRC polynomial (PCRC) for error protection of the user data. The polynomial has a Hamming distance of 4 up to a bit sequence of 2035 bits (P=0x8F3).

### Format of the Transfer Frames

According to one aspect of the present invention, the transmission frame comprises a sequence of M-bit wide words. The frame starts with an M-bit wide “comma” word from a defined sequence of comma words for the frame alignment. This is followed by K cells. The cells consist of 2, 4, 6 or 8 N-bit wide words that carry the header, payload and footer. These N-bit wide words are coded into M-bit wide symbols (line coding).

This format is selected to enable cell data to be processed at appropriate time frequencies, provided that the serializer/deserializer always processes a block of M bits.

What is claimed is:

1. A method for operating a universal data transport system for a vehicle architecture, comprising:
dividing (100) at least one physical data channel into a plurality of virtual data channels;
reading out (101) user data in a transmitter of the data transport system;
adding (102) description data describing the payload data to the payload data according to a target data format to create at least one data set;
a transmission (103) of the at least one data set by means of the virtual data channels from the transmitter to a receiver by means of static addressing, wherein several data streams are bundled in a transport frame and transmitted serially; and
receiving (104) the at least one data set in the receiver and reading out the user data for its use.

2. The method of claim 1, wherein the number of virtual data channels per physical data channel is a maximum of 128.

3. The method of claim 1, wherein a bandwidth is allocated separately for each virtual data channel.

4. The method of claim 1, wherein all virtual data channels are operated at least temporarily in a duplex mode.

5. The method of claim 1, wherein physical and/or virtual data channels of different numbers are present for each communication direction.

6. The method of claim 1, wherein the virtual data channels are set up exclusively for continuous or discontinuous data records.

7. The method of claim 1, wherein virtual data channels are prioritized independently of one another.

8. The method of claim 1, wherein network nodes of the data transport system act alternately as transmitters or receivers.

9. The method of claim 1, wherein the user data are output in the receiver by means of an output unit and/or the receiver represents a data sink.

10. The method of claim 1, wherein the method uses only volatile memories.

11. The method of claim 1, wherein the user data are present as video data and/or audio data.

12. A data transport system for a vehicle architecture, comprising:
a subdivision unit arranged to subdivide (100) at least one physical data channel into a plurality of virtual data channels;
an interface unit set up for reading out (101) user data in a transmitter of the data transport system;
a packetization unit arranged to add (102) description data describing the payload data to the payload data according to a target data format to create at least one data set;
a transmission interface unit arranged for transmitting (103) the at least one data set by means of the virtual data channels from the transmitter to a receiver by means of static addressing, wherein several data streams are bundled in a transport frame and transmitted serially; and
a receiving interface unit arranged to receive (104) the at least one data set in the receiver and to read out the user data for its utilization.

13. A computer program product comprising instructions in a non-transitory computer-readable storage medium which, when the program is executed by at least one computer, cause the computer to perform the steps of the method of claim 1.
